(19) United States
(12) Patent Application Publication
(10) Pub. No.: US 2004/0266297 A1
(43) Pub. Date: Dec. 30, 2004

(54) Composite structure for protective garment

(76) Inventors: Alan W. Schierenbeck, Dayton, OH (US); William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/899,854

(22) Filed: Jul. 27, 2004

Related U.S. Application Data
(63) Continuation-in-part of application No. 10/151,387, filed on May 20, 2002, now Pat. No. 6,806,215.
Application No. 10/151,387 is a continuation-in-part of application No. 09/659,957, filed on Sep. 12, 2000, now Pat. No. 6,658,670.

(51) Int. Cl. B32B 5/26; D04H 1/00; D03D 15/00

(52) U.S. Cl. 442/239; 442/301; 442/255; 442/268; 442/414

(57) ABSTRACT

For a protective garment, a composite structure comprising an outer shell, a moisture barrier within the outer shell, a thermally insulative liner within the moisture barrier, and a moisture absorber within the thermally insulative liner, a hydrophobic liner or a thermally insulative liner having a hydrophobic cover facing the moisture absorber is interposed between the moisture barrier and the moisture absorber. Preferably, if a hydrophobic liner is used, a thermally insulative liner is interposed between the moisture barrier and the hydrophobic liner.

### CROSS-REFERENCE TO RELATED APPLICATION

This application is a continuation-in-part of U.S. patent application Ser. No. 10/151,387, which was filed on May 20, 2002, and the disclosure of which is incorporated herein by reference. U.S. patent application Ser. No. 10/151,387 is a continuation-in-part of U.S. patent application Ser. No. 09/659,957, which was filed on Sep. 12, 2000, now U.S. Pat. No. 6,658,670 B1, the disclosure of which is incorporated herein by reference.

### TECHNICAL FIELD OF THE INVENTION

This invention pertains to a composite structure for a protective garment, such as a pair of bunker pants for a firefighter, a bunker coat for a firefighter, or a glove for a firefighter. This invention contemplates that the composite structure incorporates, along with an outer shell, a moisture barrier within the outer shell, and a moisture absorber within the moisture barrier, a hydrophobic liner between the moisture barrier and the moisture absorber.

### BACKGROUND OF THE INVENTION

Commonly, in a firefighting environment, a firefighter wearing protective garments, such as bunker pants, a bunker coat, and gloves, sweats copiously within such garments, whereby the firefighter is exposed to severe stresses due to sweating, as well as to severe stresses due to firefighting. Such stresses are known to contribute significantly to fatigue, injuries, and fatalities among firefighters.

This invention addresses an ascertained need for a composite structure, from which such garments could be made and which would employ a superabsorbent polymer to absorb copious amounts of human sweat, whereby to reduce such stresses due to sweating.

Usage of a superabsorbent polymer in a composite structure for a protective garment, such as a protective garment for a firefighter, is disclosed in U.S. Pat. No. 5,885,912 to Bumberger, the disclosure of which is incorporated herein by reference.

### SUMMARY OF THE INVENTION

This invention provides, in a protective garment, a composite structure comprising an outer shell, a moisture barrier within the outer shell, and a moisture absorber within the moisture barrier, wherein a hydrophobic liner or a thermally insulative liner having a hydrophilic cover facing the moisture absorber is interposed between the moisture barrier and the moisture absorber. In one contemplated embodiment, in which a hydrophobic liner is interposed between the moisture barrier and the moisture absorber, a thermally insulative liner is interposed between the moisture barrier and the hydrophobic liner.

In an alternative embodiment, in which a thermally insulative liner having a hydrophilic cover facing the moisture absorber is interposed between the moisture barrier and the moisture absorber, the thermally insulative liner has an outer cover facing the moisture barrier, an inner cover facing the moisture absorber, and a filler between the inner and outer covers, and the inner cover is hydrophilic. Preferably, in the alternative embodiment, the outer and inner covers are quilted so as to segregate the filler into discrete regions.

Hereinbefore and hereinafter, a reference to an element being within another element does not preclude there being an intervening element.

### BRIEF DESCRIPTION OF THE DRAWINGS

FIG. 1 and FIG. 2, respectively, are fragmentary, cross-sectional views of composite structures, each constituting one contemplated embodiment of this invention.

### DETAILED DESCRIPTION OF THE ILLUSTRATED EMBODIMENTS

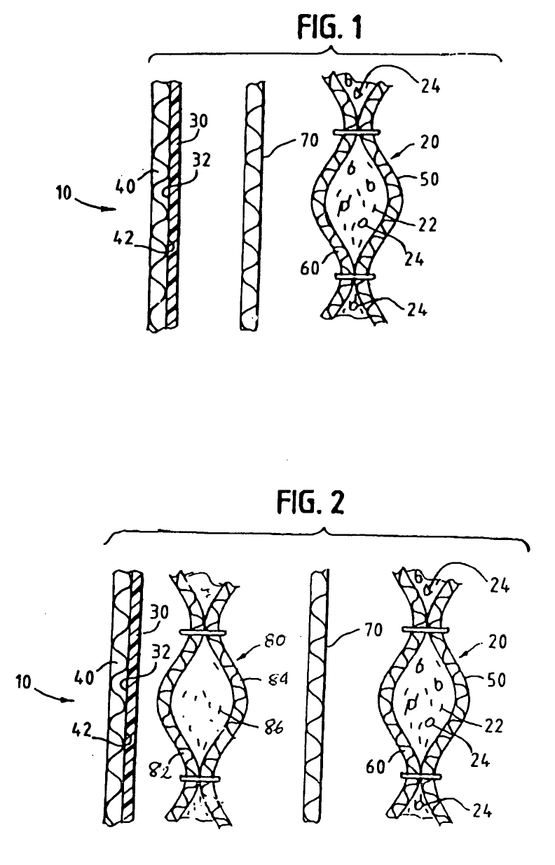

As shown in FIG. 1, a composite structure 10 for a protective garment, such as a pair of bunker pants for a firefighter, a bunker coat for a firefighter, or a glove for a firefighter, is made from fire-resistant materials and has a moisture absorber 20, a moisture barrier 30 disposed outwardly in relation to the moisture absorber 20, and an outer shell 40 disposed outwardly in relation to the moisture barrier 30. As explained below, the moisture absorber 20 incorporates a superabsorbent polymer, which may be a cross-linked polyacrylamide and which can absorb copious amounts of human sweat.

In the embodiment shown in FIG. 1, the moisture barrier 30 is affixed to the outer shell 40 so as to have surface-to-surface adhesion between an outer surface 32 of the moisture barrier 30 and an inner surface 42 of the outer shell 40. Thus, the moisture barrier 30 may be a moisture-impervious layer, e.g. a neoprene layer, which is laminated to the inner surface 42 of the outer shell 40, or a moisture-impervious layer, e.g. a Breathe Tex™ layer, which is coated on the inner surface 42 of the outer shell 40.

As shown in FIG. 1, the moisture absorber 20 has a fibrous matrix 22 incorporating particles 24 of the superabsorbent polymer. Alternatively, the fibrous matrix 22 incorporates fibers of the superabsorbent polymer. The fibrous matrix 22 is disposed between an inner cover 50, which is moisture-pervious, and an outer cover 60, which is moisture-pervious. The covers 50, 60, between which the fibrous matrix 22 is disposed, are textile layers, which are quilted to segregate discrete regions of the fibrous matrix 22.

Examples of superabsorbent polymers and processes for their incorporation into fibrous matrices are disclosed in prior patents including U.S. Pat. No. 3,670,731 to Harmon, U.S. Pat. No. 4,105,033 to Chaterjee et al, U.S. Pat. No. 4,235,237 to Mesek et al., U.S. Pat. No. 4,429,001 to Kolpin et al., U.S. Pat. No. 4,985,298 to Buckley et al., U.S. Pat. No. 5,087,513 to Kim, U.S. Pat. No. 5,328,759 to McCormack et al., and U.S. Pat. No. 5,419,955 to Ehrhardt et al., the disclosures of which are incorporated herein by reference.

In the embodiment shown in FIG. 2, the moisture barrier 30 is not affixed to the outer shell 40 so as to have surface-to-surface adhesion, as described above. Rather, the moisture barrier 20 is affixed to the outer cover 60 of the moisture absorber 20 so as to have surface-to-surface adhesion between an inner surface 34 of the moisture barrier 30 and an outer surface 62 of the outer cover 60 of the moisture absorber 20. Thus, the moisture barrier 30 may be a moisture-impervious layer, e.g. a neoprene layer, which is laminated to the outer surface 62 of the outer cover 60 of the moisture absorber 20, or a moisture-impervious layer, e.g. a Breathe Tex™ layer, which is coated on the outer cover 60 of the moisture absorber 20.

In each illustrated embodiment, a hydrophobic liner 70 is interposed between the moisture barrier 30 and the moisture absorber 20. The hydrophobic liner 70 may be made from a suitable fabric, either woven or nonwoven, which is treated so as to be hydrophobic. The hydrophobic liner 70 provides some thermal insulation and confines moisture absorbed by the moisture barrier 20 so as to prevent the inside of the moisture barrier 30 from being wetted by moisture from the moisture absorber 20. Thus, after a protective garment comprising the composite structure 10 has been used, it is not necessary to dry the inside of the moisture barrier 30.

In the embodiment shown in FIG. 2, the hydrophobic liner 70 and a thermally insulative liner 80 are interposed between the moisture barrier 30 and the moisture absorber 20, the thermally insulative liner 80 being interposed between the moisture barrier 30 and the hydrophobic liner 70. The thermally insulative liner 80 comprises an outer cover 82, an inner cover 84, and a fibrous filler 86 between the outer and inner covers 82, 84, which are quilted so as to segregate the fibrous filler 86 into discrete regions. The hydrophobic liner 70 provides some thermal insulation and confines moisture absorbed by the moisture barrier 20 so as to prevent the inner cover 84 or the fibrous filler 86, via the inner cover 84, from being wetted by moisture from the moisture absorber 20. Thus, after a protective garment comprising the composite structure 10 has been used, it is not necessary to dry the inner cover 84 or, if the inner cover 84 is not hydrophobic, to dry the fibrous filler 86 and, possibly, the outer cover 82.

In the embodiment shown in FIG. 2, if the inner cover 84 of the thermally insulative liner 80 were hydrophobic, the hydrophobic liner 70 could be omitted, as the inner cover 80 being hydrophobic would confine moisture absorbed by the moisture absorber 20 so as to prevent the fibrous filler 86 from being wetted by moisture from the moisture absorber. Thus, after a protective garment comprising the composite structure 10 had been used, it would not be necessary to dry the fibrous filler 86 and, possibly, the outer cover 84.

1. For a protective garment, a composite structure comprising an outer shell, a moisture barrier within the outer shell, and a moisture absorber within the moisture barrier, wherein a hydrophobic liner is interposed between the moisture barrier and the moisture absorber.

2. For a protective garment, a composite structure comprising an outer shell, a moisture barrier within the outer shell, a thermally insulative liner within the moisture barrier, and a moisture absorber within the thermally insulative liner, wherein a hydrophobic liner is interposed between the thermally insulative liner and the moisture absorber.

3. For a protective garment, a composite structure comprising an outer shell, a moisture barrier within the outer shell, a thermally insulative liner within the moisture barrier, and a moisture absorber within the thermally insulative liner, wherein the thermally insulative liner has a hydrophobic cover facing the moisture absorber.

4. For a protective garment, a composite structure comprising an outer shell, a moisture barrier within the outer shell, a thermally insulative liner within the moisture barrier, and a moisture absorber within the thermally insulative liner, wherein the thermally insulative liner has an outer cover facing the moisture barrier, an inner cover facing the moisture absorber, and a filler between the inner and outer covers and wherein the inner cover is hydrophobic.

5. For a protective garment, a composite structure comprising an outer shell, a moisture barrier within the outer shell, a thermally insulative liner within the moisture barrier, and a moisture absorber within the thermally insulative liner, wherein the thermally insulative liner has an outer cover facing the moisture barrier, an inner cover facing the moisture absorber, and a filler between the inner and outer covers, wherein the inner and outer covers are quilted so as to segregate the filler into discrete regions, and wherein the inner cover is hydrophobic.

6. A protective garment comprising the composite structure of any preceding claim.
